(19) United States
(12) Patent Application Publication
(10) Pub. No.: US 2025/0197241 A1
(43) Pub. Date: Jun. 19, 2025

(54) Purification of MnSO4 Solutions

(71) Applicant: Innovative Manganese Technologies SA (PTY) LTD., Cornwall Hill (ZA)

(72) Inventor: Gerard Pretorius, Cornwall Hill (ZA)

(21) Appl. No.: 18/847,598

(22) PCT Filed: Mar. 7, 2023
(86) PCT No.: PCT/IB2023/052117

§ 371 Date: Sep. 16, 2024

(30) Foreign Application Priority Data
Mar. 17, 2022 (ZA) 2022/03168

(51) Int. Cl. C01G 45/10

(52) U.S. Cl. CPC C01G 45/10

(57) ABSTRACT

The present disclosure describes a process for purifying a MnSO₄ solution including precipitating impurities from the MnSO₄ solution (i) in the presence of a stochiometric excess of fluoride anions, where said stochiometric excess of fluoride anions is calculated on the basis of the fluoride anions required to react with all Mg²⁺ and Ca²⁺ cations present in the MnSO₄ solution as impurities to form CaF₂ and MgF₂, and (ii) in the presence of sulphide anions. The precipitation is effected at a pH higher than 4, producing a slurry or suspension comprising a purified MnSO₄ solution as a carrier medium and a suspended precipitate which includes MnS, MnF₂, CaF₂ and MgF₂. The slurry or suspension is separated into the purified MnSO₄ solution and the precipitate, whereafter the precipitate is reacted with a SO₄ salt other than MnSO₄ in a solid-state reaction to produce recovered MnSO₄ from the MnS and MnF₂.

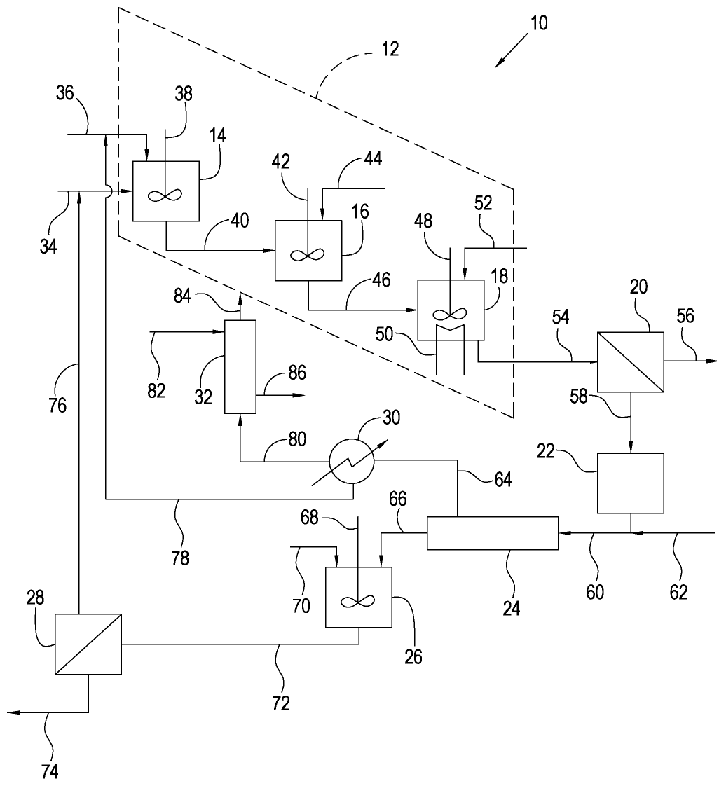

THIS INVENTION relates to purification of MnSO₄ solutions. In particular, the invention relates to a process for purifying a MnSO₄ solution.

MnSO₄ solutions of a high purity, i.e. with specified low levels of contaminants such as Ca, Co, Fe, Mg, Ni and Zn, and a minimum Mn concentration, are commercially important, e.g. for use in electrochemical cells and batteries. Various methods exist to purify MnSO₄ solutions, but they tend to be cumbersome and expensive.

A process for purifying a MnSO₄ solution which is less cumbersome and more economical than conventional MnSO₄ solution purification processes would be desirable.

According to the invention, there is provided a process for purifying a MnSO₄ solution, the process including
precipitating impurities from the MnSO₄ solution
   (i) in the presence of a stochiometric excess of fluoride anions, where said stochiometric excess of fluoride anions is calculated on the basis of the fluoride anions required to react with all Mg²⁺ and Ca²⁺ cations present in the MnSO₄ solution as impurities to form CaF₂ and MgF₂, and
(ii) in the presence of sulphide anions,
   at a pH higher than 4, producing a slurry or suspension comprising a purified MnSO₄ solution as a carrier medium and a suspended precipitate which includes MnS, MnF₂, CaF₂ and MgF₂;
separating the slurry or suspension into said purified MnSO₄ solution and said precipitate;
reacting the precipitate with a SO₄ salt (sulfate salt) other than MnSO₄ in a solid-state reaction to produce recovered MnSO₄ from the MnS and MnF₂; and
recycling the recovered MnSO₄ to the MnSO₄ solution which is being purified, thereby to reduce Mn losses and improve MnSO₄ yield.

The MnSO₄ solution may be a pregnant leach solution.

The MnSO₄ solution may be contaminated with Ca, Co, Fe, Mg, Ni and Zn as impurities. Other contaminants may include Cu, K, Na, Si, Al, Sr and Pb.

In one embodiment of the invention, the MnSO₄ solution is a leachate obtained by a roasting and leaching process, e.g. a roasting and leaching process for extracting manganese from manganese-bearing ore as disclosed in South African Provisional Patent Application No 2022/05305.

Typically, the process includes adding a base to the MnSO₄ solution to ensure that the pH is higher than 4.

The base may be NH₄OH, e.g. a 25% NH₄OH solution. Advantageously, in the process of the invention, an ammonium salt formed as a result of the addition of NH₄OH is decomposed downstream to form a treatable gas.

Preferably, during the precipitation of the impurities from the MnSO₄ solution, the pH is controlled at between about 5 and about 8, more preferably between about 5 and about 7.

The stochiometric excess of fluoride anions may be generated in the MnSO₄ solution by the addition of a stochiometric excess of a source of fluoride anions, such as a water-soluble fluoride salt or hydrofluoric acid. Preferably, the stochiometric excess of fluoride anions is generated by the addition of a stochiometric excess of a water-soluble fluoride salt, e.g. NH₄F·HF, as it is typically less hazardous than hydrofluoric acid.

Typically, the process includes agitating the MnSO₄ solution during the precipitation of impurities from the MnSO₄ solution.

Precipitating impurities from the MnSO₄ solution may include first adding a source of fluoride anions, and thereafter adding a base to the MnSO₄ solution to ensure that the pH is higher than 4.

Typically, predominantly Ca and Mg cations are precipitated from the MnSO₄ solution after the addition of the source of fluoride anions (i.e. as CaF₂ and MgF₂), in addition to some MnF₂, with the MnF₂ forming the major component (i.e. the component in the highest concentration) of the precipitate. However, other cations present in the MnSO₄ solution as impurities and that form insoluble fluorides, such as Na which forms insoluble Na₂SiF₆, may also precipitate.

The sulphide anions may be generated in the MnSO₄ solution by the addition of a source of sulphide anions. The source of sulphide anions may be selected from the group consisting of MnS, (NH₄)₂S, H₂S(g) and mixtures of two or three thereof.

In a preferred embodiment of the invention, the source of sulphide anions is MnS.

Typically, the source of sulphide anions is added to the MnSO₄ solution after the addition of a base to the MnSO₄ solution. Thus, typically, in at least one embodiment of the invention, precipitating impurities from the MnSO₄ solution includes first adding a source of fluoride anions to the MnSO₄ solution, thereafter adding a base to the MnSO₄ solution to ensure that the pH is higher than 4, and thereafter adding a source of sulphide anions to the MnSO₄ solution.

The MnS may be added to the MnSO₄ solution in a concentration of between about 2 and about 0.0001 mol MnS/litre MnSO₄ solution, preferably in a concentration of between about 1 and about 0.0005 mol MnS/litre MnSO₄ solution, more preferably in a concentration of between about 0.1 and about 0.001 mol MnS/litre MnSO₄ solution, e.g about 0.06 mol MnS/litre MnSO₄ solution.

Separating the slurry or suspension into said purified MnSO₄ solution and said precipitate may be effected using any conventional or suitable solids-liquid separation technology, e.g. filtration, gravity separation, cyclonic separation or the like.

In a preferred embodiment of the invention, the slurry or suspension is separated into said purified MnSO₄ solution and said precipitate by means of filtration. Advantageously, MnS acts as a filter aid to filter small CaF₂ and MgF₂ particles from the MnSO₄ solution, and as a precipitation agent to precipitate transition elements such as Co, Fe, Ni, Cu and Zn from the MnSO₄ solution.

Typically, the precipitation of impurities from the MnSO₄ solution in the presence of fluoride anions is effected at ambient temperature and pressure.

The precipitation of impurities from the MnSO₄ solution in the presence of sulphide anions may be effected at a temperature in the range of about 5° C. to about 100° C., preferably in the range of about 30° C. to about 80° C., more preferably in the range of about 50° C. to about 70° C., e.g. about 60° C.

The process may thus include heating the MnSO₄ solution, subsequent to the addition of a base to the MnSO₄ solution, and adding the source of sulphide anions, e.g. MnS, to the heated MnSO₄ solution.

The fluoride anions may be present in a stochiometric excess of 6 times the stochiometric amount, preferably at least 7 times the stochiometric amount, calculated on the basis of the fluoride anions required to react with all Mg²⁺ and Ca²⁺ cations present in the MnSO₄ solution to form CaF₂ and MgF₂.

The fluoride anions will typically be present in a stochiometric excess of no more than 9 times the stochiometric amount calculated on the basis of the fluoride anions required to react with all Mg²⁺ and Ca²⁺ cations present in the MnSO₄ solution to form CaF₂ and MgF₂.

Reacting the precipitate with a SO₄ salt other than MnSO₄ in a solid-state reaction may include drying the precipitate.

Reacting the precipitate with a SO₄ salt other than MnSO₄ in a solid-state reaction may include comminuting the precipitate to reduce particle size.

The precipitate may be comminuted to achieve a particle size distribution with a D90 of less than about 1000 μm, preferably less than about 500 μm, more preferably less than about 250 μm, e,g. less than 106 μm.

Typically, the precipitate is comminuted to achieve a particle size distribution with a D10 of at least 10 μm.

Reacting the precipitate with a SO₄ salt other than MnSO₄ in a solid-state reaction may include reacting the precipitate with (NH₄)₂SO₄ or NH₄HSO₄.

The SO₄ salt may have a particle size distribution with a D90 of less than about 1000 μm, preferably less than about 500 μm, more preferably less than about 250 μm, e,g. less than 106 μm.

Typically, the SO₄ salt has a particle size distribution with a D10 of at least 10 μm.

The solid-state reaction between the precipitate and the SO₄ salt may take place at a temperature in the range of about 375° C. and about 525° C., preferably about 400° C. and about 500° C., more preferably between about 425° C. and about 475° C., e.g. about 450° C.

When the SO₄ salt is, or includes, (NH₄)₂SO₄, MnF₂ present in the precipitate may react with the (NH₄)₂SO₄ in accordance with Reaction 1 as follows:

MnF₂(s)+(NH₄)₂SO₄(s)→MnSO₄(s)+NH₄F·HF(g)+NH₃(g) (1)

When the SO₄ salt is, or includes, (NH₄)₂SO₄, MnS present in the precipitate may react with the (NH₄)₂SO₄ in accordance with Reaction 2 as follows:

MnS(s)+4(NH₄)₂SO₄(s)→MnSO₄(s)+4SO₂(g)+4H₂O(g)+8NH₃(g) (2)

The process may include partially condensing off-gas generated by the solid-state reaction of the precipitate with the SO₄ salt to condense and recover NH₄F·HF from the off-gas, and to produce cooled off-gas.

The off-gas may be partially condensed at a temperature of less than about 240° C., preferably less than about 200° C., more preferably less than about 150° C., e.g. about 100° C.

Typically, the off-gas is partially condensed at a temperature of at least about 25° C.

The process may include recycling the NH₄F·HF recovered from the off-gas to act as a source of fluoride anions thereby to provide the stochiometric excess of fluoride anions for precipitating Ca and Mg impurities from the MnSO₄ solution.

The process may include scrubbing the cooled off-gas with an absorbent, e.g. water, to remove NH₃(g) from the cooled off-gas.

The process may include scrubbing the cooled off-gas in a SO₂ scrubber to desulfurize the cooled off-gas. Instead, an NH₃ scrubber employed to remove NH₃(g) from the cooled off-gas may also act as a SO₂ scrubber.

The recovered MnSO₄ may be recycled to the MnSO₄ solution as a recycle MnSO₄ solution.

The process may thus include dissolving the recovered MnSO₄ in water to form the recycle MnSO₄ solution. An insoluble waste stream may be produced, which may be withdrawn from the process and dumped. This waste stream may act as a bleed stream to prevent or control build-up of concentrations of Al, Ca, Co, Fe, K, Mg, Na, Ni and Zn in the process.

Dissolving the recovered MnSO₄ in water to form the recycle MnSO₄ solution may be effected using water at ambient temperature.

Dissolving the recovered MnSO₄ in water to form the recycle MnSO₄ solution may be effected under agitation.

The invention will now be described, by way of example, with reference to the following laboratory experiments and the single drawing which shows one embodiment of a process in accordance with the invention for purifying a MnSO₄ solution.

### Laboratory Experiments

Several laboratory experiments were conducted to investigate various aspects of the process of the invention for purifying a MnSO₄ solution.

### Material

A 4-litre volume of a pregnant leach solution of MnSO₄ with the following analysis as set out in Table 1 was used in the experiments.

TABLE 1
MnSO₄ pregnant leach solution composition (mg/l)

| Al | Ca | Co | Fe | K | Mg | Mn | Na | Ni | Zn |
|---|---|---|---|---|---|---|---|---|---|
| 1.56 | 593 | 98.3 | 13.9 | 51.6 | 1755 | 127600 | 678 | 55.4 | 2.23 |

### Fluoride Precipitation

Fluoride precipitation was used to precipitate mainly the Ca and Mg cations from the pregnant leach solution. Other cations also precipitate as insoluble fluoride precipitates, such as Na₂SiF₆. Unfortunately, MnF₂ also precipitates.

Although MnF₂ is about 100 times more soluble than CaF₂ and MgF₂, stoichiometric addition of the fluoride anion from a source of fluoride anions, such as HF or NH₄F·HF, surprisingly does not provide a MnSO₄ solution complying with battery grade specifications. There is an equilibrium and it was established that at least six, preferably seven times the stoichiometric amount of fluoride anions, calculated on the basis of the fluoride anions required to react with all Mg²⁺ and Ca²⁺ cations present in the MnSO₄ solution to form CaF₂ and MgF₂, is required comfortably to achieve an ultra-high purity MnSO₄ solution. Ammonium bifluoride (NH₄F·HF) was chosen as the source of fluoride anions because it is less hazardous than HF solutions. However, just like HF, NH₄F·HF comes at a price and NH₄F·HF consumption and losses should thus be minimised. Furthermore, because of equilibrium, a portion of MnF₂ also precipitates as mentioned hereinbefore, which leads to Mn losses and lower yields of MnSO₄. The use of expensive reagents, the formation of hazardous fluoride waste and the yield loss of Mn values can all be mitigated by implementation of at least some form of recycle.

### Calculations for Fluoride Addition

The first step was to calculate the mol amount of Mg and Ca in the 4 litre MnSO₄ solution, as follows:
Ca=0.593 g=0.014825 mol
Mg=1.755 g=0.072 mol
Total mol (Ca+Mg)=0.08705 mol/litre PLS.

The amount of NH₄F·HF required, based on a stoichiometric excess of 7 times, was then calculated as follows:
NH₄F·HF addition required=7×0.08705 mol/litre×57 g/mol NH₄F·HF×4 litres=138.93 g

### EXPERIMENTAL

The 4 litres of the pregnant leach solution was first transferred into a 5-litre plastic polypropene beaker. To this 138.93 g NH₄F·HF was added while stirring. The pH dropped from about 6 or 7 to about 3. At this pH, no precipitation occurred. To this solution, 195 ml of NH₄OH (25%) solution was slowly added while stirring until the pH reached 5, with a suspension forming. After 2 hours of stirring, the suspension was filtered. A resulting precipitate or filter cake was washed to recycle MnSO₄ trapped in the moist filter cake. The washed filter cake was then dried at 150° C. and yielded 78.5 g fluoride residue. The analysis of the washed fluoride precipitate or filter cake, i.e. residue, is provided in Table 2.

TABLE 2
Fluoride precipitate composition (wt %)

| Si | Al | Ca | Fe | Mg | Mn | Sr | Pb |
|---|---|---|---|---|---|---|---|
| 2.91 | 0.095 | 2.49 | 0.008 | 8.27 | 37.7 | 0.019 | 0.007 |

Although the fluoride precipitation removed a significant portion of the Ca and Mg from the pregnant leach solution of MnSO₄, it was found that, after filtration, the remaining pregnant leach solution (i.e. filtrate) still contains Ca and Mg levels at more than 50 ppm so that the filtrate does not comply with battery grade specifications, which require Ca and Mg at less than 50 ppm, with a minimum Mn concentration of 32%. The reason for this is that some of the MgF₂ and CaF₂ precipitated particles are too small to filter under normal laboratory conditions. The solution to this problem proposed as part of the present invention is the addition of MnS which acts as a filter aid to filter the small CaF₂ and MgF₂ particles, and also acts as a precipitation agent for the precipitation of transition elements such as Co, Fe, Ni, Cu, and Zn.

### Sulphide Precipitation

Just like the fluoride precipitate forms an equilibrium, the sulphide precipitate also forms an equilibrium. Experimentally, it was found that about 0.06 mol of MnS/litre of pregnant leach solution of MnSO₄ is enough to act as a filter aid to assist with the removal of the remaining Ca and Mg. It is also enough to precipitate all the transition elements as can be seen in the calculations below.

### Calculations of Transition Elements:

The mols transition elements in the 4 litre pregnant leach solution:
Co=0.0983 g=0.0017 mol/litre
Fe=0.0139 g=0.00025 mol/litre
Ni=0.0554 g=0.00095 mol/litre
Zn=0.0023 g=0.000034 mol/litre
Total mols of transition elements per 4 litres of pregnant leach solution=0.011736 mols

Freshly precipitated MnS was prepared via the reaction of Na₂S (60%) and battery grade MnSO₄ to produce a suspension of MnS precipitate and Na₂SO₄(aq). The MnS precipitate was filtered from the suspension and washed from any Na₂SO₄ contamination.

A total of 0.24 mol of the moist freshly precipitated MnS was added to the remainder of the 4 litres of the pregnant leach solution and heated to 60° C. After 2 hours of stirring at this temperature, a black precipitate was filtered to form a filter cake. The filter cake was washed to remove and recycle trapped MnSO₄, and then dried at 150° C., yielding 54 g sulphide residue. Table 3 provides the analysis of the sulphide precipitate. It is believed that the amount of MnS per litre pregnant leach solution can be further optimised to reduce the amount.

TABLE 3
Sulphide Precipitate composition (wt %)

| Si | Ca | Al | Fe | Mg | Mn | Ni | Pb | Zn | S |
|---|---|---|---|---|---|---|---|---|---|
| 0.24 | 0.12 | 0.015 | 0.01 | 0.29 | 49.5 | 0.356 | 0.01 | 0.017 | 8.17 |

The final, purified MnSO₄ solution had the analysis as set out in Table 4.

TABLE 4
Final MnSO₄ solution after fluoride and sulphide precipitation (mg/l)

| Ca | Co | Fe | Mg | Mn | Ni | Zn |
|---|---|---|---|---|---|---|
| 3.91 | <1 | <1 | 3.76 | 97843 | <1 | <1 |
| 12.8 ppm | <1 ppm | <1 ppm | 12.3 ppm | 32% | <1 ppm | <1 ppm |
| <50 ppm | <10 ppm | <10 ppm | <50 ppm | 32% | <10 ppm | <10 ppm |

The last row in Table 4 is the maximum allowable impurities levels for battery grade MnSO₄·H₂O, for Ca, Co, Fe, Mg, Ni and Zn. The third row in Table 4 is the level of Ca, Co, Fe, Mg, Ni and Zn impurities after fluoride and sulphide precipitation.

### Recycling of Reagents

From Table 1 the total Mn amount in the pregnant leach solution can be calculated as follows:

$$4 litres \times 127.6 g / l = 510.4 g Mn .$$

The Mn units lost to the fluoride and sulphide precipitates can also be calculated as follows:
Fluoride precipitate: 78.5 g×37.7%=29.6 g=5.8% of the starting MnSO₄ solution.
Sulphide precipitate: 54 g×49.5%=27 g=5.3% of the starting MnSO₄ solution.

The fluoride precipitate and the sulphide precipitate were separately dry milled to −106 μm. To 67.2 g of the fluoride precipitate, 110 g (NH₄)₂SO₄−106 μm was added, blended, and fired in a 3Cr12 stainless steel tube at 450° C. Calcined product from the tube was soaked for 3 hours at temperature, and after cooling to room temperature yielded 101.6 g white cake. It was found that almost all of this product is water soluble.

The MnF₂ and the (NH₄)₂SO₄ reacted in the fired tube according to the following solid-state reaction:

MnF₂(s)+(NH₄)₂SO₄(s)=MnSO₄(s)+NH₄F·HF(g)+NH₃(g)

The NH₄F·HF sublimes and can be condensed below about 240° C., e.g. below 100° C. to collect approximately 90-99% of the available fluorides.

The NH₃(g) can be scrubbed and almost all the MnSO₄(s) can be recycled back to the pregnant leach solution of MnSO₄.

To 20 g of the sulphide precipitate, 130 g (NH₄)₂SO₄−106 μm was added, blended, and fired in a 3Cr12 stainless steel tube at 450° C. Calcined product from the tube was soaked for 3 hours at temperature, and after cooling to room temperature yielded 29.6 g white cake. It was found that almost all of this product is water soluble.

The MnS and the (NH₄)₂SO₄ reacted in the fired tube according to the following solid-state reaction:

MnS(s)+4(NH₄)₂SO₄(s)=MnSO₄(s)+4SO₂(g)+4H₂O(g)+8NH₃(g)

10 g samples of the white cakes from both calcination products were dissolved in 50 ml water, filtered, and analysed. The analysis is provided in Table 5.

TABLE 5
MnSO₄ solutions obtained after dissolution of calcination
products (mg/l)

| | Al | Ca | Co | Fe | Mg | Mn | Ni | Zn |
|---|---|---|---|---|---|---|---|---|
| 10 g | <1 | 776 | 62 | 239 | 7702 | 54910 | 103 | 4.36 |
| calcined | | | | | | | | |
| fluoride | | | | | | | | |
| filter cake | | | | | | | | |
| 10 g | 127 | 338 | 1189 | 832 | 479 | 75010 | 900 | 51.8 |
| calcined | | | | | | | | |
| sulphide | | | | | | | | |
| filter cake | | | | | | | | |

As will be noted, based on the analysis set out in Table 5, the MnSO₄ solutions obtained from the solid-state reaction of the fluoride precipitate and the sulphide precipitate with (NH₄)₂SO₄ are suitable for recycling to the pregnant leach solution of MnSO₄ used at the start of the experiment, to recover Mn values.

Referring to the single drawing, reference numeral 10 generally indicates a process in accordance with the invention for purifying a MnSO₄ solution. The process 10 is a continuous process and includes a precipitation stage 12 comprising a fluoride precipitation vessel 14, a pH adjustment vessel 16 and a sulphide precipitation vessel 18. The process 10 further includes a first filter 20, a drying and comminuting stage 22, a rotary kiln 24, a dissolution vessel 26, a second filter 28, a cooler condenser 30 and an off-gas scrubber 32.

A MnSO₄ solution feed line 34 leads to the fluoride precipitation vessel 14, which is also joined by an NH₄F·HF feed line 36. The fluoride precipitation vessel 14 is provided with a stirrer 38.

A solution transfer line 40 leads from the fluoride precipitation vessel 14 to the pH adjustment vessel 16, which is also provided with a stirrer 42. An NH₄OH solution feed line 44 leads into the pH adjustment vessel 16, whereas a suspension transfer line 46 leads from the pH adjustment vessel 16 to the sulphide precipitation vessel 18.

The sulphide precipitation vessel 18 is provided with a stirrer 48, a steam heating coil 50 and a MnS feed line 52.

A suspension transfer line 54 leads from the sulphide precipitation vessel 18 to the first filter 20, which is provided with a purified MnSO₄ solution withdrawal line 56 and a filter cake transfer line 58. The filter cake transfer line 58 leads to the drying and comminuting stage 22, which is provided with a comminuted precipitate withdrawal line 60 which leads to the rotary kiln 24. The comminuted precipitate withdrawal line 60 is joined by a (NH₄)₂SO₄ feed line 62.

The rotary kiln 24 is a fired kiln which is provided with an off-gas withdrawal line 64 and a calcined precipitate withdrawal line 66, which leads to the dissolution vessel 26.

The dissolution vessel 26 is provided with a stirrer 68 and a water feed line 70.

A suspension withdrawal line 72 leads from the dissolution vessel 26 to the second filter 28, which is provided with a solids waste stream withdrawal line 74 and a MnSO₄ solution recycle line 76 which joins the MnSO₄ solution feed line 34.

The process 10 is used to purify a pregnant MnSO₄ leach solution or other MnSO₄ solution contaminated inter alia with Ca, Co, Fe, Mg, Ni and Zn as impurities.

The pregnant MnSO₄ leach solution is fed by means of the MnSO₄ solution feed line 34 into the fluoride precipitation vessel 14. A source of fluoride anions, namely NH₄F·HF is fed by means of the NH₄F·HF feed line 36 into the fluoride precipitation vessel 14 and the stirrer 38 is used to mix the two feed streams thoroughly, producing a well-mixed solution. Sufficient NH₄F·HF is fed by means of the NH₄F·HF feed line 36 to ensure a stochiometric excess of fluoride anions present in the fluoride precipitation vessel 14, equivalent to seven times the fluoride anions required to react with all Mg²⁺ and Ca²⁺ cations present as impurities in the pregnant MnSO₄ leach solution.

Although no visible fluoride precipitation takes place in the fluoride precipitation vessel 14, the pH of the well-mixed solution drops from about 6 or 7 to about 3. This well-mixed solution at a pH of about 3 is then transferred by means of the solution transfer line 40 to the pH adjustment vessel 16, where a base, namely sufficient NH₄OH in the form of a 25% NH₄OH aqueous solution, is fed into the pH adjustment vessel 16 by means of the NH₄OH solution feed line 44 to raise the pH of the solution in the pH adjustment vessel 16 to about 5. At the elevated pH in the pH adjustment vessel 16, precipitation of fluorides such as CaF₂, MgF₂ and, undesirably, MnF₂, commences. The stirrer 42 is used to ensure that a suspension is formed and maintained in the pH adjustment vessel 16. The pH adjustment vessel is sized to provide an average residence time of about 2 hours, whereafter the agitated suspension is transferred from the pH adjustment vessel 16 to the sulphide precipitation vessel 18 by means of the suspension transfer line 46.

Particulate MnS is fed into the sulphide precipitation vessel 18 by means of the MnS feed line 52 and the suspension inside the sulphide precipitation vessel 18 is agitated by means of the stirrer 48, and heated to about 60° C. by means of the steam heating coil 50. In the sulphide precipitation vessel 18 sulphides precipitate, including sulphides of Ca, Mg, Co, Fe, Ni and Zn. The CaS and MgS precipitates are thus in addition to the CaF₂ and MgF₂ precipitates that formed in the pH adjustment vessel 16.

The particulate MnS is fed into the sulphide precipitation vessel 18 at a ratio of about 0.06 mol of MnS per litre of suspension fed into the sulphide precipitation vessel 18 by means of the suspension transfer line 46.

The sulphide precipitation vessel 18 is sized to provide an average residence time of about 2 hours, whereafter the agitated suspension, comprising a suspended black precipitate, is transferred by means of the suspension transfer line 54 to the first filter 20, where the suspension is separated into a purified MnSO₄ solution or filtrate which is withdrawn by means of the purified MnSO₄ withdrawal line 56 and a precipitate or filter cake, which includes MnF₂, CaF₂ and MgF₂ as well as MnS, CaS and MgS and transition metal sulphides and/or fluorides, which is removed by means of the filter cake transfer line 58. Advantageously, the MnS acts as a filter aid to filter small precipitated CaF₂ and MgF₂ from the MnSO₄ solution, whilst also acting as a precipitation agent for transition elements such as Co, Fe, Ni, Cu and Zn.

If desired or necessary, the filter cake may be washed (not shown) with water in conventional fashion, e.g. to remove trapped MnSO₄, with filter cake wash water being recycled to the fluoride precipitation vessel 14 or to the filter 20 or to the dissolution vessel 26.

In the drying and comminuting stage 22, the filter cake or precipitate is dried in conventional fashion, e.g. at about 150° C. and then comminuted, typically by means of dry milling, to have a D90 particle size distribution of less than about 106 μm. The dry, comminuted precipitate is withdrawn by means of the comminuted precipitate withdrawal line 60 and fed to the fired rotary kiln 24. Particulate (NH₄)₂SO₄, also with a particle size distribution with a D90 of less than about 106 μm, is also fed to the rotary kiln 24 by means of the (NH₄)₂SO₄ feed line 62.

In the rotary kiln 24, the dried, comminuted precipitate and the particulate (NH₄)₂SO₄ are thoroughly admixed and heated to an elevated temperature of about 450° C., leading to solid-state reactions between the MnF₂ and the MnS present in the dried, comminuted precipitate on the one hand, and the (NH₄)₂SO₄ on the other hand, according to Reactions (1) and (2) as hereinbefore described, to produce MnSO₄(s).

After a suitably long time at the elevated temperature, e.g. about 3 hours, a solids material, i.e. calcined precipitate comprising MnSO₄(s), is withdrawn from the rotary kiln 24 by means of the calcined precipitate withdrawal line 66 and fed to the dissolution vessel 26. Water is also fed into the dissolution vessel 26 by means of the water feed line 70 with a resultant suspension formed in the dissolution vessel 26 being agitated by means of the stirrer 68. A recycle MnSO₄ solution is formed inside the dissolution vessel 26 as a result of the dissolving of the MnSO₄(s) in the water.

A suspension comprising the recycle MnSO₄ solution is withdrawn from the dissolution vessel 26 by means of the suspension withdrawal line 72 and fed to the second filter 28, where insoluble impurities are separated from the recycle MnSO₄ solution and withdrawn by means of the solids waste stream withdrawal line 74. The recycle MnSO₄ solution is transferred from the second filter 28 to the MnSO₄ solution feed line 34, by means of the MnSO₄ solution recycle line 76.

Off-gas from the rotary kiln 24 is withdrawn by means of the off-gas withdrawal line 64, and cooled and partially condensed in the cooler condenser 30. Plant cooling water is used in the cooler condenser 30 partially to condense the off-gas at a temperature of about 90° C. Condensed NH₄F·HF from the cooler condenser 30 is transferred by means of the NH₄F·HF recycle line 78 to join the NH₄F·HF feed line 36. In this way, about 90% of the fluoride anions added to the process 10 is recovered and recycled to the fluoride precipitation vessel 14.

Cooled off-gas from the cooler condenser 30 is transferred by means of the cooled off-gas line 80 to the off-gas scrubber 32, which employs water fed by means of the water feed line 82 to scrub NH₃(g) and SO₂(g) from the cooled off-gas. Scrubbed off-gas is vented from the off-gas scrubber 32 to the atmosphere by means of the vent line 84, whereas excess ammoniacal scrubbing solution is withdrawn by means of the scrubber solution withdrawal line 86.

Although described as a continuous process, as will be appreciated, the process 10 can be operated on a batch basis or on a semi-batch basis. For example, the fluoride precipitation vessel 14, the pH adjustment vessel 16 and the sulphide precipitation vessel 18 can be combined into a single vessel operated on a batch basis.

In the process 10, as illustrated, a very large proportion of the fluoride anions is advantageously recycled. By including process steps to inhibit Mn losses and to recycle Mn (e.g. by means of the rotary kiln 24, the dissolution vessel 26 and the second filter 28), the process 10, as illustrated, increases MnSO₄ yield. Advantageously, the process of the invention can produce a battery grade MnSO₄ solution with less than 1 ppm Co, Fe, Ni and Zn, and less than 15 ppm Ca and Mg, from a pregnant MnSO₄ leach solution.

1. A process for purifying a MnSO₄ solution, the process including
precipitating impurities from the MnSO₄ solution
(i) in the presence of a stochiometric excess of fluoride anions, where said stochiometric excess of fluoride anions is calculated on the basis of the fluoride anions required to react with all Mg²⁺ and Ca²⁺ cations present in the MnSO₄ solution as impurities to form CaF₂ and MgF₂, and
(ii) in the presence of sulphide anions,
at a pH higher than 4, producing a slurry or suspension comprising a purified MnSO₄ solution as a carrier medium and a suspended precipitate which includes MnS, MnF₂, CaF₂ and MgF₂;
separating the slurry or suspension into said purified MnSO₄ solution and said precipitate;
reacting the precipitate with a SO₄ salt (sulfate salt) other than MnSO₄ in a solid-state reaction to produce recovered MnSO₄ from the MnS and MnF₂; and
recycling the recovered MnSO₄ to the MnSO₄ solution which is being purified, thereby to reduce Mn losses and improve MnSO₄ yield.

2. The process according to claim 1, wherein the MnSO₄ solution is a pregnant leach solution.

3. The process according to claim 1, which includes adding a base to the MnSO₄ solution to ensure that the pH is higher than 4.

4. The process according to claim 1, wherein, during the precipitation of the impurities from the MnSO₄ solution, the pH is controlled at between 5 and 8, or between 5 and 7.

5. The process according to claim 1, wherein the stochiometric excess of fluoride anions is generated by the addition of a stochiometric excess of a water-soluble fluoride salt or hydrofluoric acid to the MnSO₄ solution.

6. The process according to claim 5, wherein the stochiometric excess of fluoride anions is generated by the addition of a stochiometric excess of a water-soluble fluoride salt.

7. The process according to claim 6, wherein the water-soluble fluoride salt is NH₄F·HF.

8. The process according to claim 1, in which the sulphide anions are generated in the MnSO₄ solution by the addition of a source of sulphide anions selected from the group consisting of MnS, (NH₄)₂S, H₂S(g) and mixtures of two or three thereof.

9. The process according to claim 8, in which the source of sulphide anions is MnS.

10. The process according to claim 1, wherein precipitating impurities from the MnSO₄ solution includes first adding a source of fluoride anions to the MnSO₄ solution, thereafter adding a base to the MnSO₄ solution to ensure that the pH is higher than 4, and thereafter adding a source of sulphide anions to the MnSO₄ solution.

11. The process according to claim 1, wherein the fluoride anions are present in the MnSO₄ solution in a stochiometric excess of at least 6 times the stochiometric amount, or at least 7 times the stochiometric amount, calculated on the basis of the fluoride anions required to react with all Mg²⁺ and Ca²⁺ cations present in the MnSO₄ solution to form CaF₂ and MgF₂.

12. The process according to claim 1, wherein reacting the precipitate with a SO₄ salt other than MnSO₄ in a solid-state reaction includes reacting the precipitate with (NH₄)₂SO₄ or NH₄HSO₄.

13. The process according to claim 12, which includes partially condensing off-gas generated by the solid-state reaction of the precipitate with the SO₄ salt to condense and recover NH₄F·HF from the off-gas, and recycling the NH₄F·HF recovered from the off-gas to act as a source of fluoride anions thereby to provide the stochiometric excess of fluoride anions for precipitating Ca and Mg impurities from the MnSO₄ solution.

14. The process according to claim 1, wherein the solid-state reaction between the precipitate and the SO₄ salt takes place at a temperature in the range of 375° C. to 525° C., or in the range of 400° C. to 500° C., or in the range of 425° C. to 475° C.

15. The process according to claim 1, wherein the recovered MnSO₄ is recycled to the MnSO₄ solution as a recycle MnSO₄ solution.
